(19) United States
(12) Patent Application Publication
(10) Pub. No.: US 2004/0086203 A1
(43) Pub. Date: May 6, 2004

(54) Database registration system and database registration method

(75) Inventors: Yukihito Furuhashi, Hachioji-shi (JP); Mikihiko Terashima, Hachioji-shi (JP); Hiroshi Matsuzaki, Hachioji-shi (JP); Takao Shibasaki, Tokyo (JP)

Correspondence Address: SCULLY SCOTT MURPHY & PRESSER, PC, 400 GARDEN CITY PLAZA, GARDEN CITY, NY, 11530

(73) Assignee: OLYMPUS CORPORATION, TOKYO (JP)

(21) Appl. No.: 10/690,904

(22) Filed: Oct. 22, 2003

(30) Foreign Application Priority Data
Oct. 23, 2002 (JP) 2002-308644

(51) Int. Cl. G06K 9/60; G06K 9/54

(52) U.S. Cl. 382/305

(57) ABSTRACT

A system in which various feature values possessed by a multimedia object are used to search for a similar object comprises a feature value calculation section configured to calculate one or more types of feature values from the multimedia object which is registered. The system further comprises a category setting section configured to set a category, which is based on the feature value calculated by the feature value calculation section, on a database storing the multimedia object. Further, the system comprises a registration section configured to associate with the multimedia object which is registered, the feature value calculated by the feature value calculation section and the category set by the category setting section and to register the multimedia object, the feature value, and the category into the database.

### CROSS-REFERENCE TO RELATED APPLICATIONS

This application is based upon and claims the benefit of priority from the prior Japanese Patent Application No. 2002-308644, filed Oct. 23, 2002, the entire contents of which are incorporated herein by reference.

### BACKGROUND OF THE INVENTION

1. Field of the Invention

The present invention relates to a database registration system and database registration method for registering multimedia objects into a database in a system in which various feature values possessed by multimedia objects as digital data such as three-dimensional data representing a shape of an object, two-dimensional image, movie, sound, and music are used to search for similar objects from a database.

2. Description of the Related Art

In recent years, multimedia objects, which are digital data, such as a static image, movie, sound, and music have been used in various scenes.

For example, concerning the data which represents three-dimensional objects, in addition to CAD data which has heretofore been used, three-dimensional object data of merchandise, digital archives of three-dimensional object data of archeological assets or art objects have actively been used. Moreover, a large number of digital image data or digital music data are exchanged via the Internet. These data are steadily increasing, and there has been a rising demand for efficient management of the data and for efficient search for the data required by a user.

To meet this demand, various techniques have been proposed. Concerning a technique of searching for the similar objects, a method of calculating features possessed by the multimedia objects to search for the objects in accordance with these feature values has been proposed. In searching for the similar object by the feature value, the similar object is designated in the object desired as a search result by the user, and the feature value of this object is compared with that of the object registered in the database, so that the similar object can be retrieved.

On the other hand, there has been a strong demand for classifying the objects into various categories and arranging the objects as a catalog. In general, when the similar object is searched in accordance with the feature value, it is necessary to first designate the object similar to that desired as a search result, and therefore the categorized/arranged catalog is required. Further, various methods for categorizing and/or searching the digital image, and computer software products have been invented. For example, in the invention disclosed in Jpn. Pat. Appln. KOKAI Publication No. 2002-140343 corresponding to U.S. patent application. Ser. No. 09/640,938, a method of selecting category information set to the digital image to be registered as an icon has been proposed. By this method, category classification can be saved/facilitated.

### BRIEF SUMMARY OF THE INVENTION

According to a first aspect of the present invention, there is provided a system in which various feature values possessed by a multimedia object are used to search for a similar object. The system comprises a feature value calculation section, a category setting section and a registration section. The feature value calculation section is configured to calculate one or more types of feature values from the multimedia object which is registered. The category setting section is configured to set a category, which is based on the feature value calculated by the feature value calculation section, on a database storing the multimedia object. The registration section is configured to associate with the multimedia object which is registered, the feature value calculated by the feature value calculation section and the category set by the category setting section and to register the multimedia object, the feature value, and the category into the database.

According to a second aspect of the present invention, there is provided a method in which various feature values possessed by a multimedia object are used to search for a similar object. The method comprises calculating one or more types of feature values from the multimedia object which is registered. The method further comprises setting a category, which is based on the calculated feature value, on a database storing the multimedia object. Further, the method comprises associating with the multimedia object which is registered, the calculated feature value and the set category to register the multimedia object, the feature value, and the category into the database.

According to a third aspect of the present invention, there is provided a system in which various feature values possessed by a multimedia object are used to search for a similar object. The system comprises feature value calculation means, category setting means and registration means. The feature value calculation means calculates one or more types of feature values from the multimedia object which is registered. The category setting means sets a category, which is based on the feature value calculated by the feature value calculation means, on a database storing the multimedia object. The registration means associates with the multimedia object which is registered, the feature value calculated by the feature value calculation means and the category set by the category setting means to register the multimedia object, the feature value, and the category into the database.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a three-dimensional interior search system to which a first embodiment of a database registration system of the present invention is applied;

FIG. 2 is a flowchart showing a database registration procedure in the first embodiment;

FIG. 3 is a diagram showing an example of an input window;

FIG. 4 is a diagram showing an example of a registration window;

FIG. 5 is a flowchart showing an update process of statistical data;

FIG. 6 is a diagram showing another example of the registration window;

FIG. 7 is a diagram showing still another example of the registration window;

FIG. 8 is a block diagram showing a constitution of a three-dimensional object robot search system to which a second embodiment of the database registration system of the present invention is applied;

FIG. 9 is a flowchart showing the database registration procedure in the second embodiment;

FIG. 10 is a diagram showing three-dimensional data acquired from a server in which the three-dimensional data produced by a CG designer is exhibited;

FIG. 11 is a point table showing a category accuracy; and

FIG. 12 is a diagram showing an example of an edition window.

### DETAILED DESCRIPTION OF THE INVENTION

Embodiments of the present invention will hereinafter be described with reference to the drawings.

It is to be noted that in the present specification, term “multimedia object” indicates three-dimensional data representing a shape of an object, and digital data such as a two-dimensional image, movie, sound, and music. Moreover, the term “feature value” indicates a numeric value which can be calculated by an arithmetic process to a multimedia object. For example, features include a surface area and volume of the three-dimensional data. A moment histogram around a major axis of a circumscribed ellipsoid of the three-dimensional data is also included. Furthermore, term “category” indicates division information to classify the multimedia objects like a catalog. For example, the division information such as “chair” and “desk” is the category for interior goods being described hereinafter in a first embodiment. The term “accuracy” means a value representing a relation between the multimedia object which is registered and each category, and represents a ratio at which the multimedia object is suitable for the category. Furthermore, the term “discriminant analysis” indicates a mathematical method to analyze multiple variables, and an analysis method in which the mathematical method is partially used. The term “attribute information” indicates various information associated with the multimedia object, such as a name, weight, price, color, and also includes information which is not calculated as the feature value of the multimedia object.

### First Embodiment

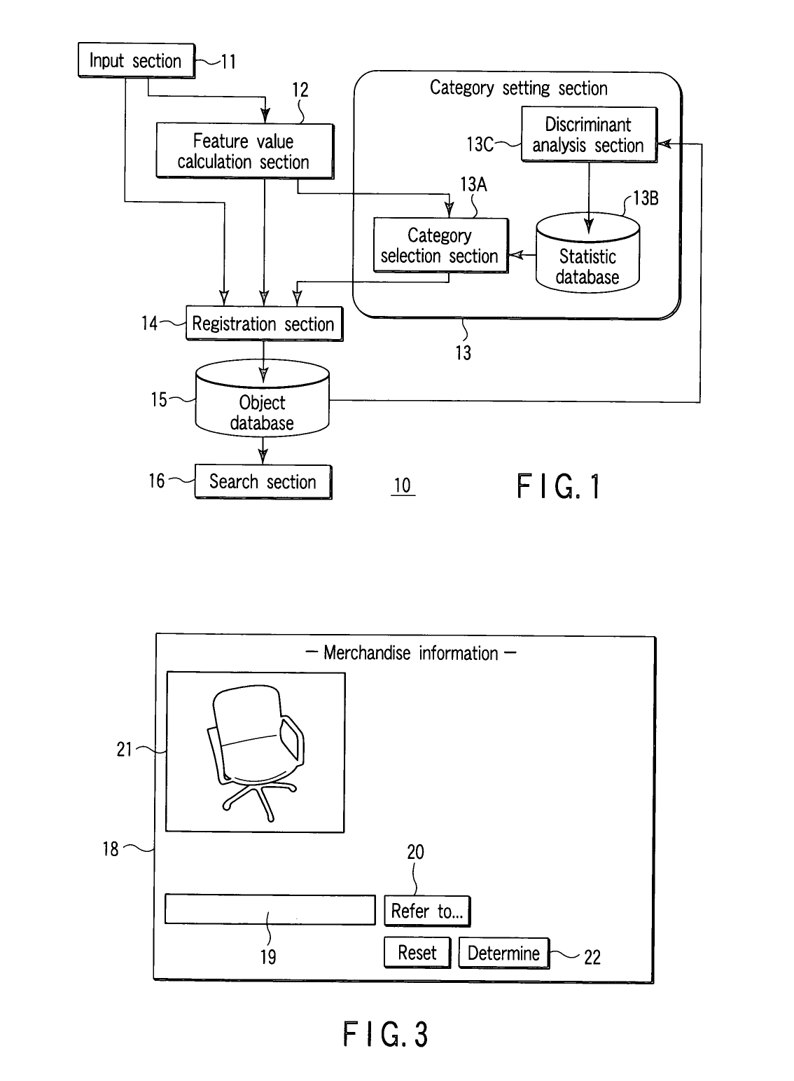

As shown in FIG. 1, a three-dimensional interior similarity search system 10 to which a first embodiment of a database registration system of the present invention is applied includes: an input section 11; a feature value calculation section 12 connected to the input section 11; a category setting section 13 connected to the feature value calculation section 12; a registration section 14 connected to the input section 11, feature value calculation section 12, and category setting section 13; an object database 15 connected to the registration section 14; and a search section 16 connected to the object database 15. The category setting section 13 includes: a category selection section 13A connected between the feature value calculation section 12 and the registration section 14; a statistic database 13B connected to the category selection section 13A; and a discriminant analysis section 13C connected to the statistic database 13B and object database 15.

Here, the input section 11 functions as an object designation section for inputting the multimedia object which is registered, that is, the three-dimensional shape data of interior goods to be registered. The feature value calculation section 12 calculates one or more types of feature values from the three-dimensional data inputted by the input section 11. The category setting section 13 sets the category into which the three-dimensional shape data inputted by the input section 11 is registered on the object database 15 based on the feature value calculated by the feature value calculation section 12. The registration section 14 associates with the three-dimensional shape data inputted by the input section 11, the feature value calculated by the feature value calculation section 12 and the category set by the category setting section 13 to register these into the object database 15. The object database 15 accumulates the three-dimensional shape data of the interior goods such as a chair and a table, attribute data such as name/price, category information, and feature value data. The search section 16 receives the search conditions from a user, and retrieves the three-dimensional interior data, which match the search conditions, from the object database 15. It is to be noted that the present embodiment is characterized by a database registration section in the similarity search system, and therefore description of details of the constitution and search method of the search section 16 is omitted.

Moreover, the discriminant analysis section 13C of the category setting section 13 discriminates/analyzes the feature value of the three-dimensional shape data registered in the object database 15 against the category. The statistic database 13B stores discriminant analysis results of the discriminant analysis section 13C. The category selection section 13A compares the feature value calculated by the feature value calculation section 12 with the discriminant analysis result stored in the statistic database 13B to select the category recommended as the registration end. The recommended category is provided to the user in the registration section 14, and the user determines the category to register the object.

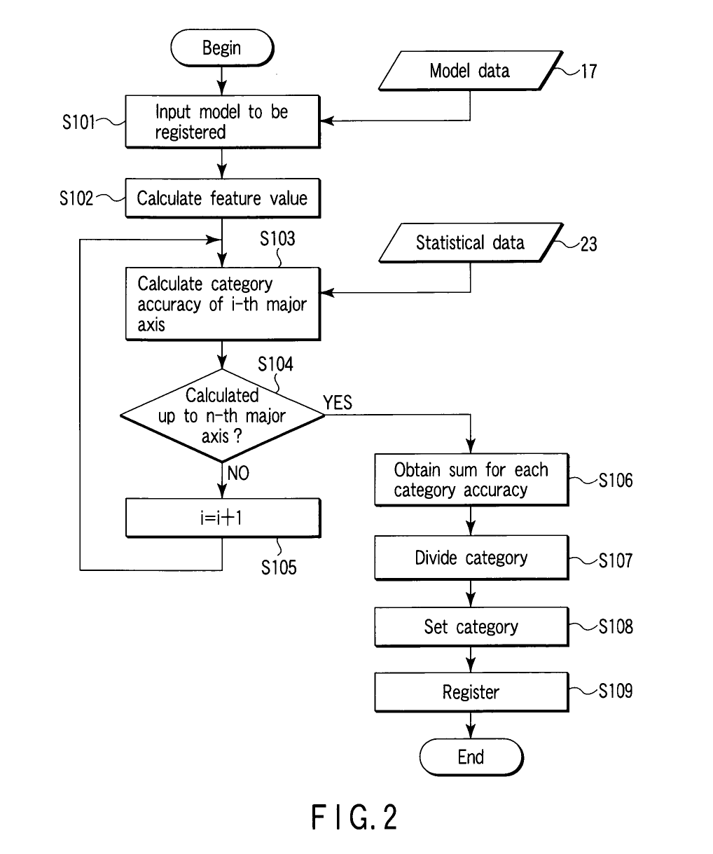

Next, a database registration operation in the three-dimensional interior similarity search system 10 constituted as described above will be described with reference to a flowchart shown in FIG. 2. That is, first the user inputs the three-dimensional shape data of the interior goods to be registered on the input section 11 (step S101). The three-dimensional shape data is model data 17 such as data prepared by CAD, and the like, and data taken in by a three-dimensional scanner. An operation for actually inputting the model data 17 in this step S101 is carried out using an input window 18 which is displayed, for example, on a screen of a display (not shown) and which is shown in FIG. 3. That is, an input field 19 for inputting the three-dimensional shape data is disposed in the input window 18. When an address of the model data 17 to be registered (folder and file names or URL address, and the like on a storage medium (not shown)) is described/inputted in the input field 19, the corresponding model data 17 is specified. Alternatively, when a folder tree displayed by the operation (e.g., click) of a “refer” button 20 disposed in the vicinity of the input field 19 is traced to designate a file, and the name of the file is inputted into the input field 19, the corresponding model data 17 is also specified. The model data 17 specified in this manner is read from the storage medium (not shown), and displayed in a three-dimensional display region 21 disposed in the input window 18. Moreover, by the operation of a “determine” button 22, the read model data 17 is supplied to the feature value calculation section 12 and registration section 14.

Next, the feature value calculation section 12 calculates the feature value from the model data 17 inputted via the input section 11 (step S102). As the calculated feature values, there are used a histogram obtained by quantizing values for each color information such as RGB, HSV, and Lab which can be calculated with respect to texture of a three-dimensional object, a shape histogram obtained by quantizing edge derivatives, a histogram of a volume, surface area, vertex distribution, and polygon distribution of the three-dimensional object, and the like. It is to be noted that these feature values may also be extracted from various portions, and obtained as separate feature values. This calculated feature value is sent to the category selection section 13A of the category setting section 13, and the registration section 14.

Subsequently, the category selection section 13A uses statistical data 23 stored in the statistic database 13B of the category setting section 13 to calculate category accuracy on each major axis with respect to the feature value calculated by the feature value calculation section 12 (steps S103 to S105). Here, the major axis indicates a mathematical concept represented by a vector (hereinafter referred to as major axis data) obtained as a result of the discriminant analysis of feature value data of the interior goods stored in the object database 15. When the feature value data is f-dimensional, this major axis data is also an f-dimensional vector. When the number of categories is c, the major axis data exists to a (c−1)th major axis from a first major axis. Examples of the statistical data 23 include major axis data obtained by the discriminant analysis of the feature value data of the interior goods stored in the object database 15, and average value and standard deviation on each major axis data of the category.

That is, in the step S103, first an inner product Fᵢ of major axis data Aᵢ representing an i-th major axis and feature value data f of the interior goods to be registered is calculated.

Fᵢ=Aᵢ●F (1)

Next, when the inner product Fᵢ is assigned to an accuracy function t(x,cᵢ), an accuracy t(Fᵢ, cᵢ) is calculated with respect to a category cᵢ.

t(x,cᵢ)=exp(−1/2×((x−m_{—}cᵢ)/s_{—}cᵢ)²) (2),

where s_cᵢ and m_{—c}ᵢ denote the standard deviation and average value on the i-th major axis of the category cᵢ.

The standard deviation s_ci and average value m_cᵢ of the category cᵢ are stored in the object database 15. When the calculation of the above equation (2) is carried out with respect to all the categories, the category accuracy with respect to the i-th major axis can be calculated.

Subsequently, in the step S104, it is judged whether or not the calculations of all the major axes have been performed. When there is still a remaining major axis, in the step S105, an index i of the major axis as an object is increased, and thereafter the step returns to the step S103.

Therefore, when the calculation is completed with respect to all the major axes (step S104), next, the category selection section 13A calculates each category accuracy (step S106). For each category accuracy, the average value of the category accuracies calculated with respect to the respective major axes in the step S103 is obtained for each category. That is, a category accuracy t(cᵢ) with respect to the category cᵢ of the interior goods to be registered is as follows:

t(cᵢ)={t(F₁,cᵢ)+t(F₂,cᵢ)++t(F_{C-1},cᵢ)}/(c−1) (3)

Thereafter, the category selection section 13A divides the category into “recommended categories” and “the other categories” in accordance with a threshold value of the category accuracy (step S107). In this case, the threshold value of the category accuracy may be set beforehand in the present system, or may also be set by the user. The information of the categories divided in this manner is transferred to the registration section 14. For the registration section 14, the user finally sets the category (step S108), and the category is associated with the model data 17 inputted via the input section 11 and the feature value calculated by the feature value calculation section 12, and registered in the object database 15 (step S109).

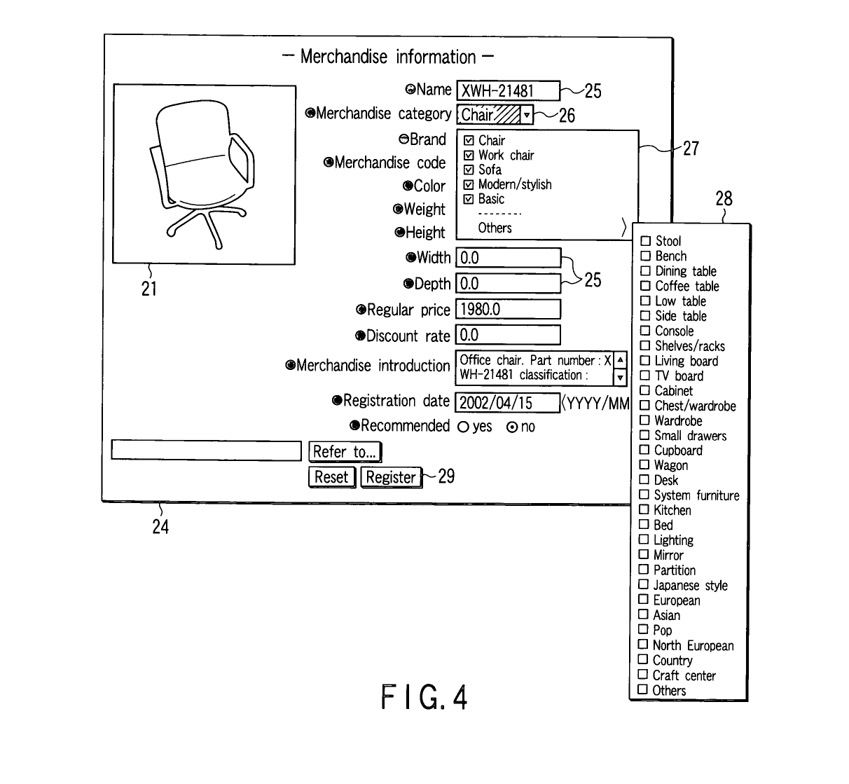

The category setting in the step S108 is carried out using a registration window 24 shown in FIG. 4. That is, in the same manner as in the input window 18, the three-dimensional display region 21 for displaying the model data 17 to be registered, which has been inputted via the input section 11, that is, the three-dimensional shape of the interior goods is disposed in the registration window 24. Further in the registration window 24, a plurality of input fields 25 for inputting attribute information such as the name, and merchandise category setting field 26 for setting the category are displayed.

The user can describe/input the attribute information of the interior goods into the input field 25 which functions as an attribute designation section. It is to be noted that the attribute information is information associated with the model data 17, and the examples include information which is not calculated as the feature value from the model data 17, such as name, merchandise code, size, weight, manufacturing date, registration date, merchandise description, and thumb nail image.

On the other hand, for the merchandise category setting field 26, when the merchandise category setting field 26 is clicked, as shown in FIG. 4, a list 27 is displayed to display “the recommended categories” divided in the step S107. At this time, “the recommended categories” constitute a list of the categories having a high possibility that the interior goods to be registered belong to the category, and therefore the list is in a pre-selected state (checked state of a check box). Among the categories included in the list 27 indicating “the recommended categories”, when there is a category judged not to be registered by the user, the selected state can be cancelled.

Moreover, in the list 27 displaying “the recommended categories”, selection elements referred to as “the others” representing a set of “the other categories” divided in the step S107 are also displayed. When the user clicks “the others” in the list 27 displaying “the recommended categories”, a list 28 displaying “the other categories” can be displayed. The “other categories” constitute a list of categories having a low possibility that the interior goods to be registered belong to the categories, and are not selected beforehand. When there are categories to be judged to be registered by the user among the categories included in the list 28, these can be selected.

Subsequently, after filling in the attribute information into the input field 25 and selecting/setting the category, a “register” button 29 in the registration window 24 is clicked, and accordingly the registration is completed. That is, when the “register” button 29 is clicked, the model data 17 representing the three-dimensional shapes of the inputted interior goods, the calculated feature value data, and the set attribute information are registered in the object database 15 together with the category information set by the user.

It is to be noted that the search section 16 can use the information registered in the object database 15 to carry out a search process.

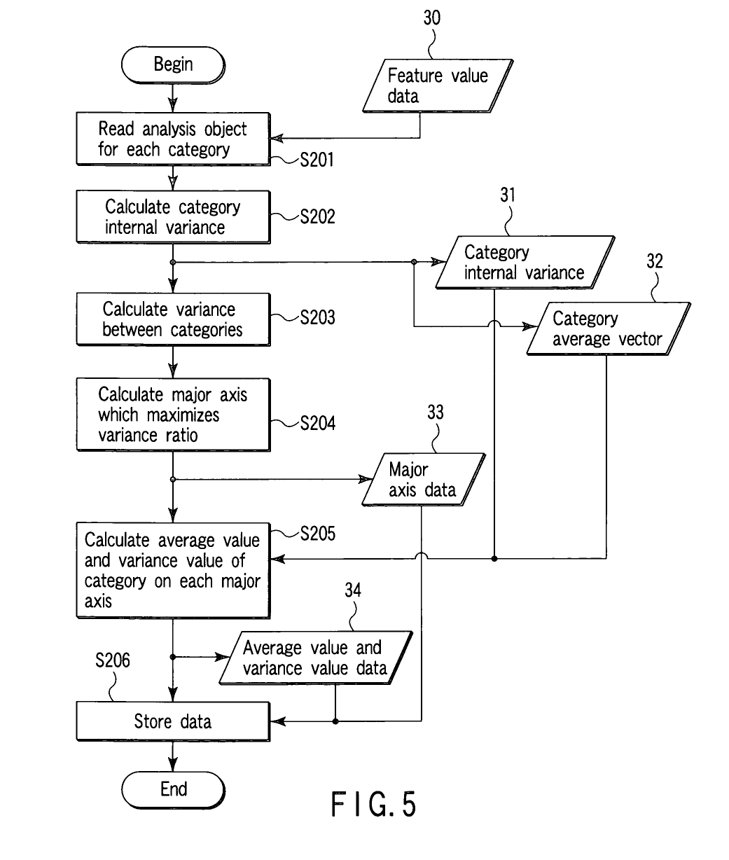

Next, a procedure for updating the statistical data stored in the statistic database 13B of the category setting section 13 will be described with reference to a flowchart shown in FIG. 5. It is to be noted that steps in FIG. 5 are executed in the discriminant analysis section 13C of the category setting section 13.

That is, the discriminant analysis section 13C first reads feature value data 30 of all the interior goods stored in the object database 15 (step S201). The feature value data 30 is arranged for each category.

Next, a category internal variance 31 with respect to each category, and category internal variance average W which is the average value of the variances are calculated from the feature value data read in the step S201 (step S202). Here, the category internal variance is an amount indicating a variance-covariance matrix of the feature value data which belongs the category, and a spread of the category. In this calculation process, a category average vector 32 is also obtained. The category average vector is an amount which is obtained by averaging the feature value data belonging to the category as a vector and which indicates a central position of the category.

Next, a variance between the categories B is calculated from the feature value data 30 read in the step S201 and the category average vector 32 calculated in the step S202 (step S203). Here, the variance between the categories is an amount indicating the variance-covariance matrix of each category average vector 32, and mutual spread of the respective categories.

Thereafter, major axis data y is calculated, which maximizes a variance ratio r constituted of the category internal variance average W calculated in the step S202, and the variance between the categories B calculated in the step S203.

r=(y^{t}By)/(y^{t}Wy) (4)

This calculation is generally an eigenvalue problem of the matrix, and finally a set Y (major axis data 33) of the major axis data y is obtained corresponding to the eigenvalue in order from a large eigenvalue (step S204). Here, the respective major axes corresponding to the eigenvalue in order from the large eigenvalue are referred to as a first major axis, second major axis, . . . . This major axis data y is a vector which has the same number of dimensions as that of the feature values. Assuming that the number of categories is c and the number of dimensions of the feature value is n, the set Y of the major axis data y is represented as the matrix including c−1 rows and n columns.

Next, average value and variance value data 34 of the category on each major axis is calculated (step S205). That is, an average value m_{ci} of the category on the i-th major axis is obtained from i-th major axis data yᵢ and category average vector mc (category average vector 32) obtained in the step S202.

m_{ci}=mc×yᵢ (5)

Moreover, for a variance value W_{ci} of the category on the i-th major axis, the variance value of each category is obtained from the i-th major axis data yᵢ and category internal variance W_{c} (category internal variance 31) obtained in the step S202.

W_{ci}=yᵢ^{t}Wcyᵢ (6)

When the above equations (5) and (6) are calculated for each major axis and each category, the average value and variance value data 34 of the category on each major axis is obtained.

Subsequently, the set Y of the major axis data obtained in the step S204 (major axis data 33) and the average value and variance value data 34 of the category on each major axis obtained in the step S205 are stored as the data (step S206). A storage end is the statistic database 13B. The data stored in the statistic database 13B in this manner is used as the statistical data 23 in the category selection section 13A.

It is to be noted that the statistical data update process shown in FIG. 5 is carried out every time new interior goods are registered.

As described above, in the first embodiment, the feature value calculation section 12 calculates the feature value from the three-dimensional data of the interior goods inputted by the user. That is, the feature value which is an essential constituting element of the similarity search system is used to provide a function of registration category judgment. That is, the category setting section 13 automatically judges the category to be registered from a relation between the feature value of the interior goods already registered in the database, and that of the interior goods to be registered, and presents the category to the user. As a result, the user can easily determine the category which is the registration end of the interior goods, and can efficiently carry out a registration operation.

Moreover, the category setting section 13 arranges the categories in order of the accuracy calculated based on the discriminant analysis, when presenting the category to be registered to the user. Furthermore, when presenting the category to be registered to the user, the category setting section 13 hierarchically displays the category having a high accuracy calculated based on the discriminant analysis, and the category having a low accuracy as separate lists. Therefore, even when the number of categories is large, the display is not troublesome. As a result, the user can easily judge the category having a high possibility of suitability.

By the above-described effect, the user of the present system can enhance efficiency of the operation for registering the interior goods into the similarity search system.

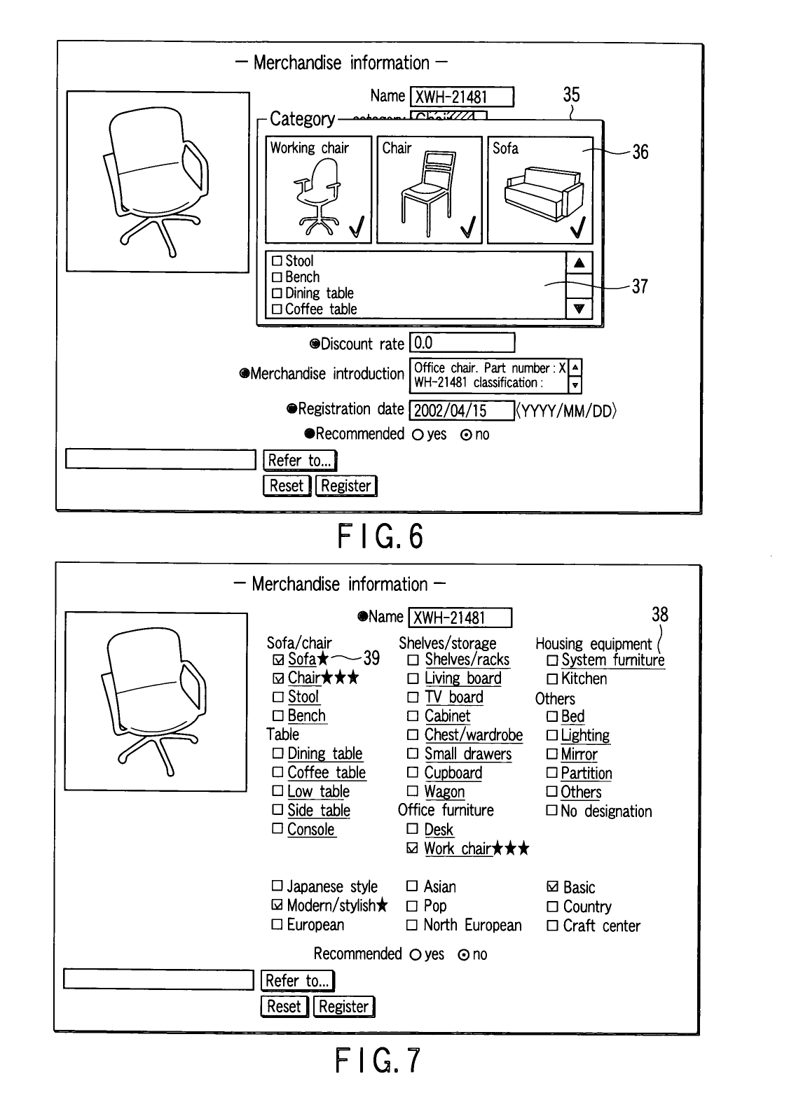

It is to be noted that the merchandise category setting field 26 shown in FIG. 4, the list 27 displaying “the recommended categories”, and the list 28 displaying “the other categories” may also be provided in the form of a category setting region 35 shown in FIG. 6. That is, the category setting region 35 includes a region 36 indicating “the recommended categories” and a region 37 indicating “the other categories”. Moreover, in the region 36 indicating “the recommended categories”, a category which is selected by the category selection section 13A and which has a high accuracy is represented by the image which represents the category. The region 37 indicating “the other categories” constitutes a name list of categories which are selected by the category selection section 13A and which have the low accuracy. The order of the categories shown in the region 36 indicating “the recommended categories” and the region 37 indicating “the other categories” is based on the accuracy calculated in the category selection section 13A. When the category is displayed by the image in this manner, the user can more easily judge whether or not to register the goods into the category.

Moreover, the merchandise category setting field 26 shown in FIG. 4, the list 27 displaying “the recommended categories”, and the list 28 displaying “the other categories” may also be provided in the form of a category setting region 38 shown in FIG. 7. That is, the category setting region 38 indicates all the categories which exist in the present system, and the category can be selected by a check box. Moreover, among the categories displayed in the category setting region 38, the categories selected as “the recommended categories” in the category selection section 13A are displayed together with star symbols 39 representing “the recommended categories”. The number of star symbols 39 changes in accordance with a degree of accuracy calculated in the category selection section 13A. It is to be noted that “the recommended categories” are in a selected state beforehand. When “the recommended categories” are displayed together with the symbols in this manner, and even when the user carries out an operation for canceling the selected states of “the recommended categories”, the user can easily reconfirm “the recommended categories” judged by the present system.

It is to be noted that the input field 25 for inputting the attribute information, such as the name, as shown in FIG. 4, may also be displayed in the input window 18 for use in inputting the three-dimensional shape data of the interior goods in the input section 11, not in the registration window 24 for setting the category. The attribute information does not necessarily have to be inputted in the registration window 24, and a data file in which the attribute information has been described may also be simultaneously inputted, when inputting the three-dimensional shape data in the input section 11. Furthermore, the three-dimensional shape data and attribute information data may also constitute the same file.

Moreover, the accuracy function t(x,cᵢ) used in the calculation performed in the step S103 is not limited to the function of the above equation (2). Instead of calculating the accuracy of each category as the sum of accuracy functions, the accuracy may also be the result of the discriminant analysis with respect to each major axis. For example, when the discriminant analysis result of the first major axis is “chair” and that of the second major axis is “work chair”, the “chair” is assumed as the category having the highest accuracy and the “work chair” is assumed as the category having the next high accuracy.

Moreover, a display configuration of the region 37 indicating “the other categories” of FIG. 6 may also be the image in the same manner as in the region 36 indicating “the recommended categories”.

Furthermore, the step of updating the statistical data stored in the statistic database 13B shown in FIG. 5 does not have to be necessarily carried out every time new interior goods are registered, and may be carried out every time 100 goods are registered, or every month.

Additionally, the search object is not limited to the interior goods, and includes any multimedia object. For example, the inputted object is not limited to a three-dimensional model, and may also be a two-dimensional image. Multimedia objects such as a movie and sound may also be searched. That is, the form of the inputted object is not limited as long as the feature value can be calculated.

### Second Embodiment

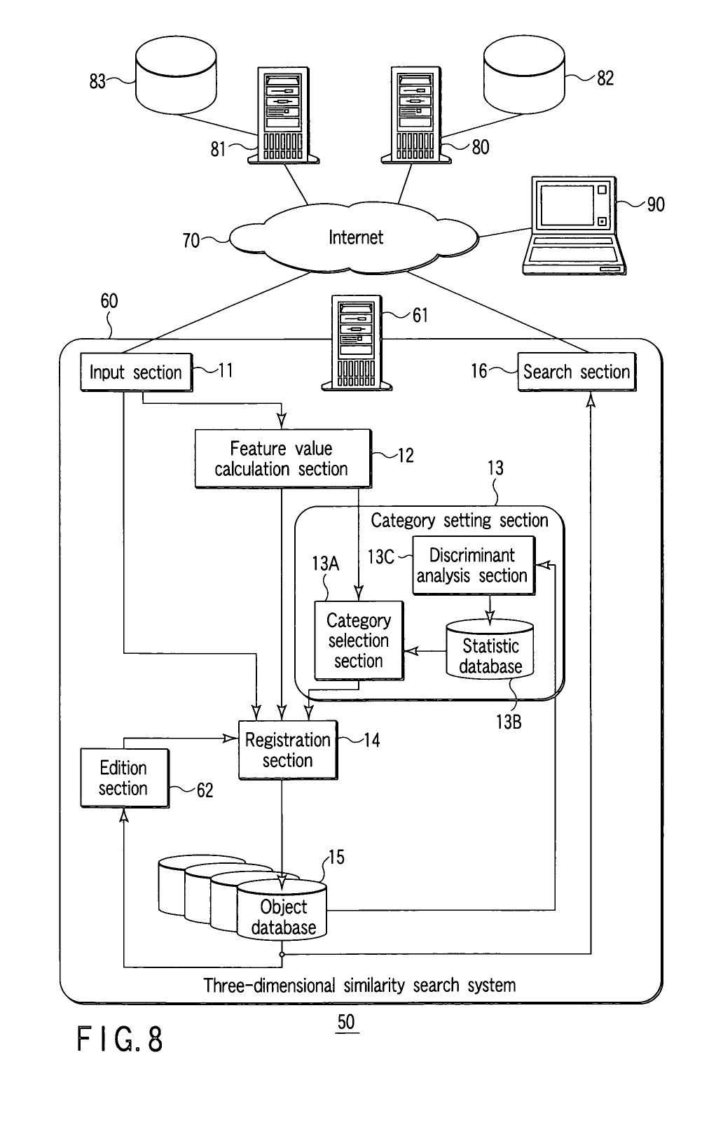

Next, a second embodiment of the present invention will be described. As shown in FIG. 8, in a three-dimensional object robot search system 50 to which the second embodiment of the database registration system of the present invention is applied, a three-dimensional similarity search system 60 is constructed on a server 61. The three-dimensional similarity search system 60 is constituted of constituting elements substantially similar to those of the three-dimensional interior similarity search system 10 in the first embodiment. Therefore, in the figure, components similar to those in the first embodiment are denoted with the same reference numerals, and description of the components is omitted.

Here, for hardware, the server 61 is connected to the Internet 70. For the system, the input section 11 and search section 16 are connected to the Internet 70. In the present embodiment, the input section 11 forms a program referred to as a robot or a crawler, and automatically collects information which meets the conditions from the Internet 70. That is, the input section 11 has a function of collecting URL including an extension representing the three-dimensional data, and an extension attached to the extension and indicating compressed data to acquire the data corresponding to each URL on the Internet 70.

Moreover, the object database 15 in which the search object is stored is divided into a plurality of databases for each search category in the three-dimensional similarity search system 60. The three-dimensional similarity search system 60 includes an edition section 62 connected to the object database 15 and registration section 14. This edition section 62 edits the information of the three-dimensional data stored in the object database 15, and the information can be re-registered in the registration section 14.

On the other hand, the Internet 70 is also connected to a server 80 which exhibits the three-dimensional data produced by a CG designer, and a server 81 which provides merchandise information with the three-dimensional data. These servers 80 and 81 are connected to databases 82, 83 for storing the three-dimensional data. The Internet 70 is further connected to a client 90 which performs the search.

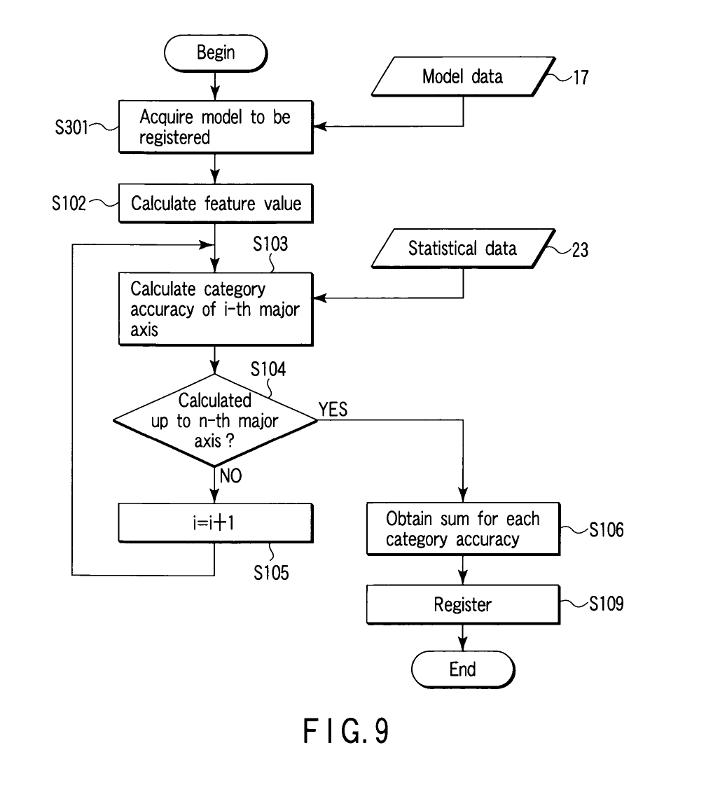

Next, a procedure for the registration into the object database 15 in the above-described constitution will be described with reference to a flowchart shown in FIG. 9. That is, first the input section 11 acquires the URL indicating the three-dimensional data, and acquires the three-dimensional data (model data 17) corresponding to the URL on the Internet 70 (step S301). That is, the input section 11, which is a robot, successively traces links of URLs on the Internet 70. Accordingly, the URL of the three-dimensional data existing on the server and the corresponding three-dimensional data (model data 17) are automatically acquired, for example, from the server 80 which exhibits the three-dimensional data produced by the CG designer and the server 81 which provides the merchandise information with the three-dimensional data.

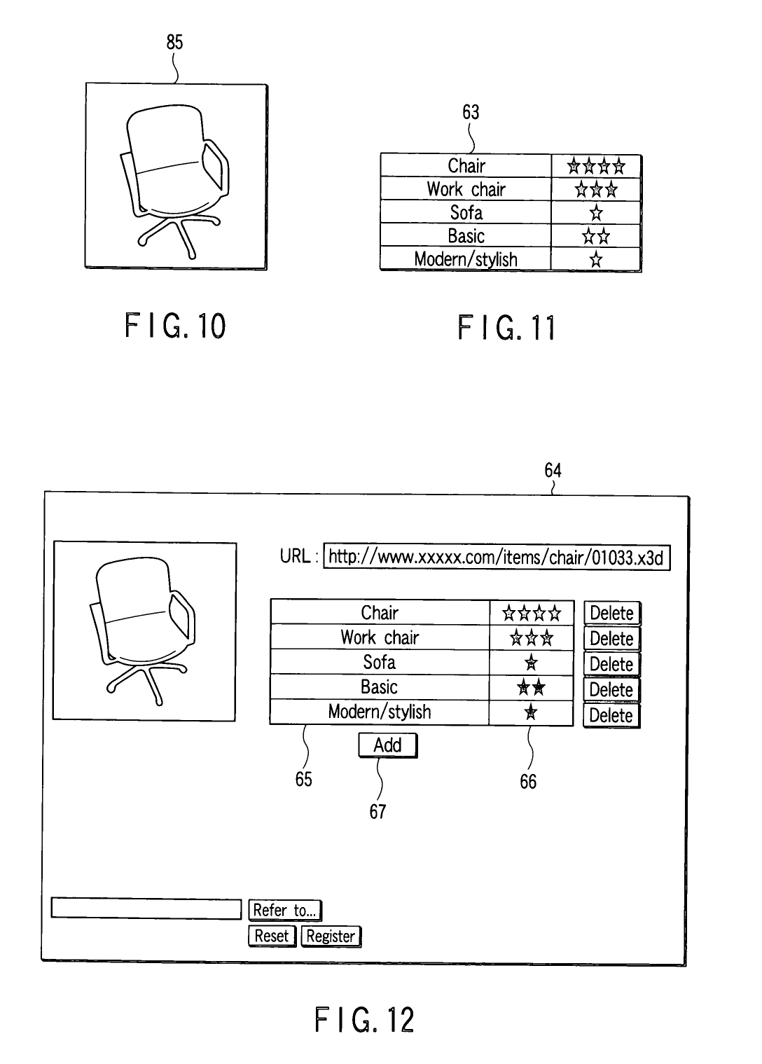

Thereafter, the feature value is calculated from the three-dimensional data (model data 17) acquired in the step S301 and each category accuracy is calculated in the same manner as in the steps S102 to S106 in the first embodiment. Subsequently, in the present embodiment, without performing the process of the steps S107 and S108 of the first embodiment, each category accuracy calculated in the step S106 is registered as the category information of the data acquired in the step S301 into the object database 15 (step S109). For example, to register three-dimensional data 85 acquired from the server 80 which exhibits the three-dimensional data produced by the CG designer and shown in FIG. 10, a point table 63 indicating the category accuracy as shown in FIG. 11 is obtained as a result of the step S106. It is to be noted that the category having point “0” is deleted in the point table 63. For this point, the accuracy of the category is linearly converted to correspond to “5” from “0”. In the present embodiment, since the object database 15 is divided so as to correspond to each category, the three-dimensional data 85 is registered into each object database corresponding to the category shown in the point table 63 together with point information of the category.

The information is automatically registered as described above. Additionally, in the present embodiment, the edition section 62 can edit the category information of the three-dimensional data stored in the object database 15. In this case, as shown in FIG. 12, a category name 65 and a value 66 corresponding to the category name are displayed in an edition window 64. Moreover, the edition section 62 can edit the value 66. Moreover, the user can add the category by an “add” button 67.

It is to be noted that a function of discriminant analysis in the discriminant analysis section 13C is similar to the procedure shown in FIG. 5 of the first embodiment.

According to the second embodiment, by the input section 11, the present system can automatically acquire the three-dimensional data on the Internet 70. The category setting section 13 automatically judges the category of the three-dimensional data inputted from the input section 11 based on a result of statistical analysis of the feature value registered in the object database 15 and the feature value of the three-dimensional data calculated by the feature value calculation section 12. In the registration section 14, the three-dimensional data inputted via the input section 11, the feature value of the three-dimensional data calculated by the feature value calculation section 12, and the category information set by the category setting section 13 are automatically registered in the object database 15. As a result, in the present system, when an initial setting is only applied to the input section 11, the three-dimensional data is automatically collected from the Internet 70, and can be registered in an appropriate category together with the feature value, and this can replace the user's database registration operation.

Moreover, since the category setting section 13 calculates the accuracy of the category and the registration section 14 also registers the category accuracy into the object database 15, in the edition section 62, as shown in the edition window 64, the category set by the category setting section 13 can be confirmed and edited together with the category accuracy. As a result, the user can refer to the judgment result of the present system to more easily edit the category information.

Furthermore, the object database 15 is a variance database divided for each category, and the registration section 14 registers various data in the object database corresponding to the category set based on the feature value of the three-dimensional data by the category setting section 13. That is, the three-dimensional data registered in the object database is data which is approximate as the feature value. As a result, even when the database scatters, it is easy to mainly search the data which is approximate as the feature value during the similarity search, and it is possible to realize efficient similarity search.

It is to be noted that the category accuracy is not limited to the point of “0” to “5” as shown in the point table 63, and may be the numeric value itself as the result of the step S106.

Moreover, the input section 11 is not limited to a configuration having a function of the robot described in the present embodiment, and may be, for example, a configuration for separately indicating the three-dimensional data to be acquired by the user.

Furthermore, the search object is not limited to the three-dimensional data, and includes all multimedia objects. For example, the multimedia objects such as a two-dimensional image, movie, and sound may also be searched. That is, the form of the object to be inputted is not limited as long as the feature value can be calculated.

The present invention has been described above based on the embodiments, but the present invention is not limited to the above-described embodiments and, needless to say, the present invention can be variously modified or applied within the scope of the present invention.

For example, as the list indicating the categories having the accuracies which are not less than the set threshold value, the list 27 displaying “the recommended categories” of FIG. 4, and the region 36 indicating “the recommended categories” of FIG. 6 have been described as the examples. The display configuration is not limited to this, and also includes a list to which an icon is attached, and a table. Similarly, the list indicating the category of the accuracy which is less than the threshold value also corresponds to the list 28 displaying “the other categories” in FIG. 4 and the region 37 indicating “the other categories” in FIG. 6, but the display configuration is not limited to this, and also includes the list to which the icon is attached and the table.

Moreover, the example of the symbol representing the accuracy has been described in accordance with the star symbol 39 of FIG. 7, but the display configuration is not limited to this, and includes configurations such as the accuracy represented by a length of a bar, a numeric value indicating the accuracy, and a character.

Furthermore, the example of the storage section has been described in accordance with the statistic database 13B, but is not limited to the configuration of the database, and also includes the configuration of the file.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A system in which various feature values possessed by a multimedia object are used to search for a similar object, comprising:
a feature value calculation section configured to calculate one or more types of feature values from the multimedia object which is registered;
a category setting section configured to set a category, which is based on the feature value calculated by the feature value calculation section, on a database storing the multimedia object; and
a registration section configured to associate with the multimedia object which is registered, the feature value calculated by the feature value calculation section and the category set by the category setting section and to register the multimedia object, the feature value, and the category into the database.

2. The system according to claim 1, wherein the category setting section automatically selects the category based on the feature value calculated by the feature value calculation section, and
the registration section automatically registers the multimedia object which is the registration object and the feature value of the multimedia object into the database together with the category automatically selected by the category setting section.

3. The system according to claim 1, wherein the category setting section selects the category based on the feature value calculated by the feature value calculation section to provide an initial value of a registration end category candidate which is to be presented to a registerer.

4. The system according to claim 1, wherein the category setting section selects a plurality of categories based on the feature value calculated by the feature value calculation section, and displays the plurality of selected categories in order of high accuracy.

5. The system according to claim 4, wherein the category setting section displays the plurality of categories selected based on the feature value as a list indicating the categories having the accuracy which is not less than a set threshold value, and a list indicating the categories having the accuracy which is less than the threshold value.

6. The system according to claim 1, wherein the category setting section selects the category which is the registration end based on the feature value calculated by the feature value calculation section, and displays the selected category to which a symbol representing the accuracy is attached.

7. The system according to claim 1, wherein the category setting section includes:
a discriminant analysis section configured to discriminate/analyze the feature value of the registered multimedia object with respect to the registration-end category; and
a storage section configured to store a discriminant analysis result of the discriminant analysis section, and uses the discriminant analysis result stored in the storage section to select the category which is the registration end.

8. The system according to claim 7, wherein the discriminant analysis section discriminates/analyzes the feature value with respect to the registered objects including the multimedia object constituting the registration object, after the category setting section determines the registration end of the multimedia object.

9. The system according to claim 1, further comprising:
an object designation section configured to designate an arbitrary multimedia object as the multimedia object which is the registration object; and
an attribute designation section configured to carry out at least one of designation and input of attribute information of the multimedia object designated by the object designation section.

10. The system according to claim 1, wherein the category setting section includes an attribute designation section configured to carry out at least one of designation and input of attribute information of the multimedia object which is the registration object.

11. A method in which various feature values possessed by a multimedia object are used to search for a similar object, comprising:
calculating one or more types of feature values from the multimedia object which is registered;
setting a category, which is based on the calculated feature value, on a database storing the multimedia object; and
associating with the multimedia object which is registered, the calculated feature value and the set category to register the multimedia object, the feature value, and the category into the database.

12. A system in which various feature values possessed by a multimedia object are used to search for a similar object, comprising:
feature value calculation means for calculating one or more types of feature values from the multimedia object which is registered;
category setting means for setting a category, which is based on the feature value calculated by the feature value calculation means, on a database storing the multimedia object; and
registration means for associating with the multimedia object which is registered, the feature value calculated by the feature value calculation means and the category set by the category setting means to register the multimedia object, the feature value, and the category into the database.
